(19) United States
(12) Patent Application Publication
(10) Pub. No.: US 2007/0296554 A1
(43) Pub. Date: Dec. 27, 2007

(54) Radio Frequency Identification (Rfid) Device Programing System and Method

(75) Inventors: Christopher Marcus, Simpsonville, SC (US); John Ford, Boca Raton, FL (US); Mark Grimes, Delray Beach, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronic Corporation, Boca Raton, FL (US)

(21) Appl. No.: 11/791,093

(22) PCT Filed: Nov. 30, 2005
(86) PCT No.: PCT/US05/43413

§ 371 Date: May 16, 2007

Related U.S. Application Data
(60) Provisional application No. 60/632,658, filed on Dec. 2, 2004.

(51) Int. Cl. G06K 7/00; G06K 19/08

(52) U.S. Cl. 340/10.51

(57) ABSTRACT

A radio frequency identification (RFID) device programming system and method may be used to provide pre-programmed RFID devices, for example, as a roll of RFID devices that may be later applied to articles or items. The programming system may include a plurality of RFID probes configured to apply programming signals to the RFID devices and a RFID programmer connected to the probes and configured to generate the programming signals. The programming system may also include a web positioning mechanism configured to position a web including the RFID devices such that the group of RFID devices is positioned in within a programming range of the probes. A controller may be configured to control the web positioning mechanism such that sequential groups of the RFID devices are programmed.

### TECHNICAL FIELD

The present invention relates to radio frequency identification (RFID) devices and more particularly, to a RFID device programming system and method.

### BACKGROUND INFORMATION

Radio frequency identification (RFID) systems are generally known and may be used for a number of applications such as managing inventory, electronic access control, security systems, automatic identification of cars on toll roads, and electronic article surveillance (EAS). RFID devices may be used to track or monitor the location and/or status of articles or items to which the RFID devices are applied. A RFID system typically comprises a RFID programmer and a RFID device such as a tag or label. The RFID programmer may transmit a radio-frequency carrier signal to the RFID device. The RFID device may respond to the carrier signal with a data signal encoded with information stored on the RFID device. RFID devices may store information such as a unique identifier or Electronic Product Code (EPC) associated with the article or item.

RFID devices may be programmed (e.g., with the appropriate EPC) and applied to the article or item that is being tracked or monitored. According to one technique, the RFID devices are programmed, one at a time, at the point of application to a product. The time it takes to program and verify the RFID devices in a one up fashion at the point of application limits the application speed. Conventional non-RFID label applicators used in product lines are capable of running at speeds up to 300 parts per minute. When RFID encoding or programming is required, label applicator speed may be reduced down to around 50 parts per minute. When a defective label is detected using these conventional techniques, it may be removed from the process and another label may be re-encoded in its place. Each defective label that is encountered may cut the product application rate by up to an additional 50%. As a result, product lines may run at speeds of around 25 parts per minute so as not to miss a product in the event a defective label is detected.

Accordingly, there is a need for a system and method of programming RFID devices that allows the programmed RFID devices to be applied to articles or items at higher speeds.

### BRIEF DESCRIPTION OF THE DRAWINGS

These and other features and advantages of the present invention will be better understood by reading the following detailed description, taken together with the drawings wherein:

FIG. 1 is a functional block diagram illustrating an RFID programming system, consistent with one embodiment of the present invention.

FIG. 2 is a schematic diagram illustrating an RFID programming station, consistent with one embodiment of the present invention.

FIG. 3 is a flow chart illustrating a method of programming RFID devices, consistent with one embodiment of the present invention.

### DETAILED DESCRIPTION

In general, a radio frequency identification (RFID) device programming system and method may be used to provide pre-programmed RFID devices for later application to articles or items. The pre-programmed RFID devices may be applied to articles or items (e.g., products or merchandise) using conventional applicators such as non-RFID label applicators that are capable of higher application speeds.

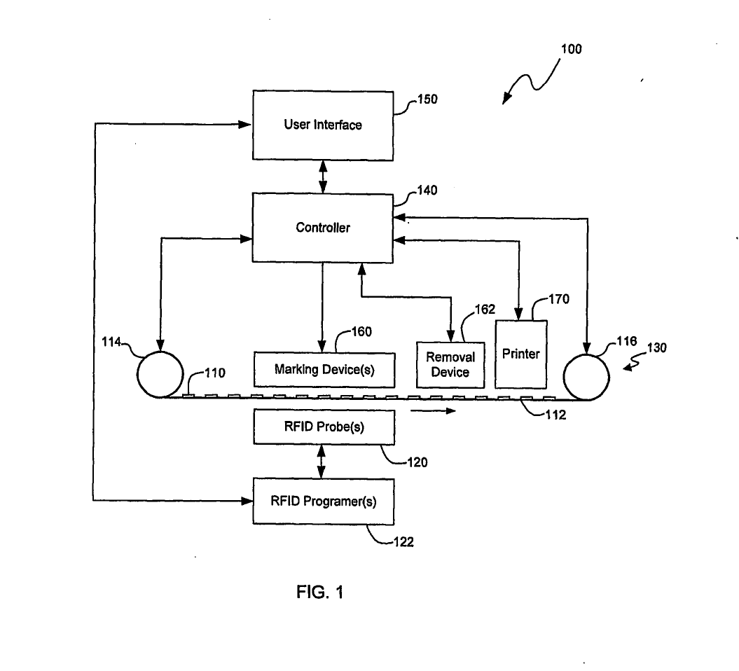

Referring to FIG. 1, one embodiment of a RFID device programming system 100 may be used to program RFID devices 110 supported on a web 112. The web 112 may be provided as a roll 114 of non-programmed RFID devices 110, which is unwound as the web 112 passes through the programming system 100. After passing through the programming system 100, the web 112 may be wound onto a roll 116 of programmed RFID devices 110. Although the web 112 supporting the RFID devices 110 is arranged in rolls 114, 116 in the illustrated exemplary embodiment, the web 112 may be arranged in other configurations such as a fanfold box.

In one example, the RFID devices 110 may be RFID labels having an adhesive on one side and the web 112 may be a backing material. The RFID labels may be removably adhered to the backing material such that the RFID labels are supported on the backing material during programming and may be removed for application. The RFID devices 110 may be any RFID label or tag known to those skilled in the art such as, for example, the “Combo EAS/RFID Label or Tag” disclosed in U.S. Provisional Patent Application Ser. No. 60/628,303, which is fully incorporated herein by reference.

The RFID device programming system 100 may include one or more RFID probes 120 to apply programming signals to the RFID devices 110 and one or more RFID programmers 122 connected to the RFID probe(s) 120 to generate the programming signals. The programming signals may be generated and applied to program each of the RFID devices 110 with a unique electronic product code (EPC) using techniques known to those skilled in the art and according to industry standards. The RFID device programming system 100 may also include a web positioning mechanism 130 to position the web 112 such that the RFID devices 110 on the web 112 are positioned in within a programming range of the RFID probe(s) 120. A controller 140 and a user interface 150 may be used to control the RFID device programming system 100, as will be described in greater detail below.

The RFID device programming system 100 may also include one or more marking devices 160 located over the RFID probe(s) 120 to mark any defective RFID devices 110. One embodiment of the marking device 160 includes one or more markers with black light sensitive or permanent ink that marks the RFID devices 110. The markers may be controlled by pneumatic or motor controlled actuators using techniques known to those skilled in the art.

The programming system 100 may also include a printer 170 to print indicia, such as bar codes and/or UPC codes, on the RFID devices 110. In the illustrated exemplary embodiment, the printer 170 is located downstream to print on the top surface of the RFID devices 110 after the RFID devices 110 are programmed as they pass through the programming system 100 to the winding roll 116. Those skilled in the art will appreciate that the printer may also be located in other locations.

The RFID device programming system 100 may also include a removal device 162 to remove defective RFID devices from the web 112. One example of a removal device is a mechanism that acts in opposite sequence of a bullet nose web rewind mechanism such as the mechanism disclosed in U.S. Provisional Patent Application Ser. No. 60/605,035, which is fully incorporated herein by reference. Alternatively, an applicator (not shown) used to apply RFID devices may include a removal device capable of detecting and removing RFID devices that were marked defective by the RFID device programming system.

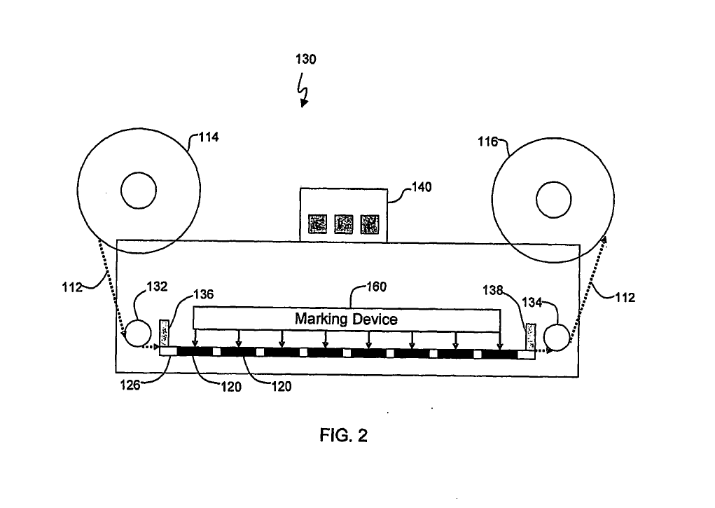

According to one embodiment, as shown in FIG. 2, a plurality of RFID probes 120 may be oriented along a flat plat 126 and arranged with a spacing corresponding generally to the spacing of the RFID devices 110 on the web 112. For example, the probe spacing may be arranged to match the repeat length of the labels on the web. Although eight probes 120 are shown in FIG. 2, any number of probes may be used for programming. Each of the RFID probes 120 may also be adjustable in order to enable each of the probes 120 to align with the center of each RFID device 110 being programmed.

According to one embodiment, the RFID probes 120 may be near-field probes such as the type disclosed in U.S. Provisional Patent Application Ser. No. 60/624,402, which is fully incorporated herein by reference. The programming range of a near-field probe is generally the near-field zone of the probe. The near field probe may be implemented by enhancing the magnitude of the induction field within the near-near field zone associated with an antenna structure and decreasing the magnitude of the radiation field within the far-field zone associated with the antenna structure. One embodiment of the near field probe may include a stripline antenna terminated into a 50 ohm chip resistor. In one example, the near field probe may have an operating frequency of 915 MHz and the near-field zone may be approximately 5 cm from the probe.

The RFID programmer 122 may be any RFID programmer known to those skilled in the art for programming and/or reading RFID devices, such as the type known as the Sensormatic® SensorID™ Agile 2 Reader available from Tyco Fire and Security. The Sensormatic® SensorID™ Agile 2 Reader includes eight ports for connecting to the RFID probes 120. The RFID programmer 122 may also be capable of detecting defective RFID devices, for example, by attempting to read a RFID device after applying programming signals via the probes 120.

As shown in FIG. 2, one embodiment of the web positioning mechanism 130 may include one or more rollers 132, 134. A first roller 132 on the unwind side of the programming system 100 guides the web 112 from the unwinding roll 114 to the probes 120. A second roller 134 on the wind side of the programming system 100 guides the web 112 to the winding roll 116 of programmed RFID devices. The web positioning mechanism 130 may also include one or more stepper drive motors (not shown) coupled to the rolls 114, 116 to unwind, wind and/or rewind the rolls 114, 116.

The web positioning mechanism 130 may further include a tension spring 136 or other similar device to maintain the web 112 in position relative to the RFID probes 120 as the web 112 is advanced. The web positioning mechanism 130 may further include one or more sensors 138 to sense the RFID devices on the web 112 and to assist in positioning the RFID devices. One example of a sensor 138 is a label sensor that senses the edge of a label using techniques known to those skilled in the art. Although one embodiment of the web positioning mechanism is shown, those skilled in the art will appreciate that other web positioning mechanisms may be used to position a web and RFID devices with respect to one or more RFID probes.

The controller 140 may be coupled to the stepper drive motors and the sensor 138 to control positioning of the web 112 such that the RFID devices are aligned with the RFID probes 120. The controller 140 may also be coupled to the marking device(s) 160, the removal device 162 and/or the printer 170 to control the marking, removal and printing operations, respectively. According to one embodiment, the controller 140 may be a programmable logic controller (PLC), such as the type available from Allen-Bradley, Omron or Mitsubishi, or a general purpose computer, such as a PC, programmed to control the positioning of the RFID devices 110 with respect to the RFID probes 120 and to control the marking, removal and/or printing operations.

The user interface 150 may also be coupled to the controller 140 to receive positioning information from the controller 140 and to provide commands or other parameters to the controller 140. The user interface 150 may be coupled to the RFID programmer 122 to control the RFID programming operations. In general, the user interface 150 may control the RFID programming operations, for example, by allocating EPC's and/or other data to be sent to the RFID devices 110 upon receiving an indication by the controller 140 that the RFID devices 110 are properly positioned. The user interface 150 may also collect programming data and statistics and provide such data to the user, for example, in the form of a report associated with a programmed roll of RFID devices. The user interface 150 may be implemented as a user interface program running on the PLC or PC using programming techniques known to those skilled in the art. The user interface 150 may also be implemented using a separate system such as an existing warehouse management system (WMS) that is configured for RFID.

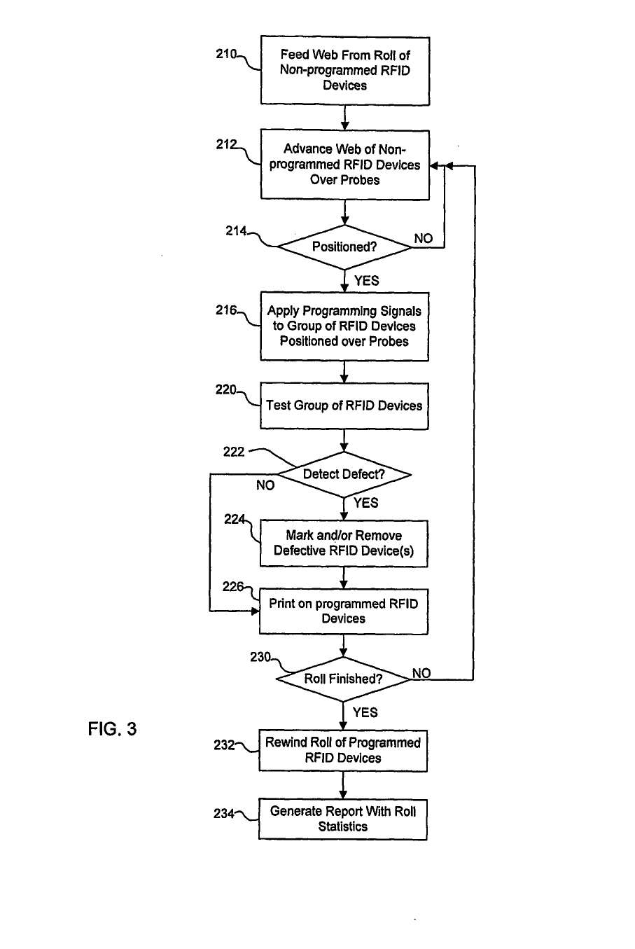

Referring to FIG. 3, one method of operating the RFID device programming system 100 to program RFID devices is described in greater detail. To initiate operation, the roll 114 or other arrangement of non-programmed RFID devices 110 may be loaded onto the unwinding side of the programming system 100. The operator may then feed the web 112 through the programming system 100 to the winding side, operation 210. In the exemplary embodiment, the web 112 may be threaded around the roller 132, beneath the tension spring 136, between the marking device(s) 160 and the probes 120, beneath the label sensor 138, and around the roller 134.

The programming system 100 may then be operated to advance the web 112 over the RFID probes 120, operation 212, until the system determines that a group of non-programmed RFID devices 110 is positioned over the RFID probes 120, operation 214. The RFID probes 120 may apply programming signals to the RFID devices 110 positioned over the probes, operation 216. In the exemplary embodiment, the web 112 may be advanced by using the controller 140 to control the stepper motor(s) to unwind the roll 114 and to wind the roll 116. The position may be determined by using the controller 140 to monitor the sensor 138, which senses one of the RFID devices when a group of RFID devices 110 are aligned with the probes 120. When the controller 140 receives a position signal from the sensor 138 indicating that the RFID devices are in the proper stopping position, the controller 140 may stop the stepper motor(s) to stop advancement of the web 112. The controller 140 may then send a positioning command to the user interface 150 when the RFID devices 110 are stopped in the proper stopping position over the probes 120. The programming signals may be applied by using the user interface 150, upon receiving the positioning command, to allocate a group of consecutive EPC's (i.e., one to each probe 120) and to cause the RFID programmer 122 to send programming signals corresponding to each of the RFID devices 110 stopped in position over the probes 120.

The system 100 may also test the RFID devices 110 to determine if any RFID devices are defective, operation 220. If a defect is detected in a RFID device 110, operation 222, the RFID device may be marked defective and/or removed from the web 112, operation 224. In the exemplary embodiment, the RFID devices 110 may be tested by using the RFID probes 120 and RFID programmer 122 to attempt to read the RFID devices 110 after programming. If a RFID device cannot be read by a probe 120, the user interface 150 may send a defect command to the controller 140 indicating which of the probes 120 detected the defective RFID device 110. The RFID device may be marked by using the controller 140 to actuate the marking device 160 above the defective RFID device. The RFID device may be removed by using the controller 140 to actuate the removal device 162 to remove the defective RFID device from the web 112 entirely.

The system 100 may also print on the RFID devices, operation 226, for example, after the devices are programmed. In the exemplary embodiment, the controller 140 may be used to index the group of programmed RFID devices to the printer 170. The controller 140 and/or the user interface 150 may then be used to cause the printer 170 to print indicia corresponding to each of the programmed RFID devices, such as bar codes, UPC codes, and the EPC code programmed in the label.

If the system 100 determines that the roll 114 of non-programmed RFID devices is not finished, operation 230, the system 100 may advance the web again until another group of RFID devices is positioned over the RFID probes 120 and the operations described above may be repeated. If the roll of non-programmed RFID devices is finished, the system 100 may rewind 232 the web 112 from the roll 116 back to the roll 114. In the exemplary embodiment, the tension spring 136 and label sensor 138 may be disengaged and the stepper drive motors may be controlled to perform the rewinding operation. The rewinding operation may be performed to ensure proper EPC label position on the roll, thereby producing a roll of pre-programmed RFID devices that may be used in a conventional non-RFID applicator.

After the completion of an entire pre-programmed roll of RFID devices, a report may be generated including programming statistics for the programmed RFID devices on the roll, operation 234. In the exemplary embodiment, the user interface program 150 may be used to collect the statistics and to generate the report automatically. The statistics on the report may include, but are not limited to, the total number of labels, the number of “good” (i.e., not defective) labels, the number of “bad” (i.e., defective) labels, the total percentage yield for the roll, the EPC range for the roll, and the statistics for each individual RFID probe 122 in the programming system 100. Although the programming is described in connection with the exemplary embodiment of the RFID device programming system 100, other RFID device programming systems may be used to practice the method described herein.

RFID device programming systems and methods, consistent with the present invention, may thus be used to encode RFID labels, print, and remove or mark defective labels at relatively high speeds. One embodiment of the RFID device programming system may be capable of running over 600 RFID labels per minute. The preprogrammed labels may then be used in manual and/or automatic applications, for example, in a “build to order” fashion. This enables product lines to run at higher speeds because the label applicator may simply apply the pre-programmed label onto the product without having to program the labels and without having to handle defective labels. The roll statistic reports may provide details about the rolls in advance of application to the product.

Consistent with one embodiment, a RFID device programming system may include a plurality of RFID probes configured to apply programming signals to a group of RFID devices simultaneously and a RFID programmer connected to the probes and configured to generate the programming signals for the RFID devices. The programming system may also include a web positioning mechanism configured to position a web including the RFID devices such that the group of RFID devices is positioned within a programming range of the probes. A controller may be configured to control the web positioning mechanism such that sequential groups of the RFID devices are programmed.

Consistent with another embodiment, a method of programming RFID devices may include providing a web supporting RFID devices, advancing the web until a group of the RFID devices are positioned over a plurality of RFID probes, and applying programming signals simultaneously to the RFID devices in the group when the group of RFID devices is positioned over the plurality of RFID probes.

Consistent with a further embodiment, a method of producing a roll of programmed RFID devices may include providing a roll of RFID devices, unwinding the roll of RFID devices, applying programming signals to the RFID devices as the roll of RFID devices unwinds, and re-winding a roll of programmed RFID devices.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A radio frequency identification (RFID) device programming system comprising:
a plurality of RFID probes configured to apply programming signals to a group of RFID devices;
a RFID programmer coupled to said probes and configured to generate said programming signals for said RFID devices;
a web positioning mechanism configured to position a web including said RFID devices such that said group of said RFID devices is positioned within a programming range of said probes; and
a controller configured to control said web positioning mechanism such that sequential groups of said RFID devices are programmed.

2. The RFID device programming system of claim 1 wherein said RFID programmer is configured to determine if said RFID devices are defective, and further comprising at least one marking device positioned opposite said probes and configured to mark defective RFID devices.

3. The RFID device programming system of claim 2 further comprising a removal device configured to remove said defective RFID devices.

4. The RFID device programming system of claim 1 further comprising a sensor configured to sense a position of said RFID devices and to provide a position signal to controller.

5. The RFID device programming system of claim 1 further comprising a printer positioned relative to said web positioning mechanism and configured to print on said RFID devices.

6. The RFID device programming system of claim 1 wherein said RFID devices include labels.

7. The RFID device programming system of claim 1 wherein said web positioning mechanism includes rollers configured to guide said web between said probes and said marking device.

8. A method of programming RFID devices, said method comprising:
providing a web supporting RFID devices;
advancing said web until a group of said RFID devices is positioned adjacent a plurality of RFID probes; and
applying programming signals to said RFID devices in said group when said group of RFID devices is positioned over said plurality of RFID probes.

9. The method of claim 8 further comprising:
determining if any of said RFID devices are defective; and
if any of said RFID devices are determined to be defective, marking said defective RFID devices.

10. The method of claim 9 further comprising removing said defective RFID devices.

11. The method of claim 8 wherein said RFID devices include RFID labels removably adhered to said web.

12. The method of claim 8 wherein programming signals include at least a unique Electronic Product Codes (EPC) for each of said RFID devices.

13. The method of claim 8 further comprising printing on said RFID devices.

14. The method of claim 8 further comprising generating a report including statistics associate with said roll of programmed RFID labels.

15. The method of claim 8 wherein said web supporting said RFID devices is provided as a roll of non-programmed RFID devices.

16. The method of claim 15 wherein said web is advanced repeatedly until said programming signals have been applied to all of said RFID devices on said roll of non-programmed RFID devices.

17. The method of claim 16 wherein advancing said web includes unwinding said roll of non-programmed RFID devices and winding a roll of programmed RFID devices.

18. The method of claim 17 further comprising rewinding said roll of programmed RFID devices.

19. A method of producing a roll of programmed RFID devices, said method comprising:
providing a roll of RFID devices;
unwinding said roll of RFID devices;
applying programming signals to said RFID devices as said roll of RFID devices unwinds; and
re-winding a roll of programmed RFID devices.

20. The method of claim 19 wherein said programming signals are applied simultaneously to groups of said RFID devices as said roll of RFID devices unwinds.
